(19) United States
(12) Patent Application Publication
(10) Pub. No.: US 2025/0380326 A1
(43) Pub. Date: Dec. 11, 2025

(54) TECHNIQUES FOR IMPROVED USER EQUIPMENT RETRY TIMER

(71) Applicant: T-Mobile USA, Inc., Bellevue, WA (US)

(72) Inventor: Tommy Yau, Sammamish, WA (US)

(21) Appl. No.: 18/737,788

(22) Filed: Jun. 7, 2024

(51) Int. Cl. H04W 76/18; H04L 65/1016; H04L 65/1045

(52) U.S. Cl. CPC H04W 76/18; H04L 65/1016; H04L 65/1045

(57) ABSTRACT

Techniques are described herein for providing intelligent connection retry timing as implemented on user equipment (UE). Such techniques may comprise determining that a first attempt to establish a connection with a network has failed, receiving, from a computing device separate from the UE, a retry interval value associated with the first attempt to establish the connection, performing a wait operation over an amount of time associated with the retry interval value, and performing, at the expiration of the amount of time, a second attempt to establish the connection with the network. In these techniques, the retry interval values to be used may vary based on one or more conditions associated with the failed connection attempt.

### BACKGROUND

Internet Protocol Multimedia Subsystem (IMS) is an architectural framework defined by the 3rd Generation Partnership Project (3GPP) for delivering Internet Protocol (IP) multimedia to user equipment (UE) of the IMS network. An IMS core network (sometimes referred to as the “IMS core”, the “Core Network (CN),” or the “IM CN Subsystem”) permits wireless and wireline devices to access IP multimedia, messaging, and voice applications and services. IMS allows for peer-to-peer communications, as well as client-to-server communications over an IP-based network.

During a registration procedure with the IMS core network, the UE is assigned a serving call session control function (S-CSCF) node and an application server (AS). These assigned nodes are tasked with serving the UE during a subsequent communication session, and all signaling originating from, and terminating at, the UE during the communication session is to be routed through the assigned nodes of the IMS core.

In a typical IMS network architecture, when a UE is unable to connect to the IMS core network, that UE is not able to use services that include both voice services and data services. In such cases, the UE may be hard-coded to attempt to reestablish a connection with the IMS core network at predetermined intervals. However, such predetermined intervals may not be optimal for every scenario.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 depicts a diagram illustrating an overview of a network architecture 100 having a number of components that may be implemented in accordance with some embodiments.

FIG. 2 depicts a component diagram of an example system to be implemented in a network in order to enable implementation of dynamic connection retry timers.

FIG. 3 depicts a block diagram illustrating exemplary interactions between a number of components that may be implemented in accordance with some embodiments.

FIG. 4 depicts a swim lane diagram illustrating a process for enabling implementation of dynamic connection retry timers in accordance with at least some embodiments.

FIG. 5 depicts a flow chart illustrating an exemplary process for performing a connection retry process in accordance with some embodiments.

FIG. 6 depicts a flow diagram illustrating an exemplary process for providing intelligent connection retry timing in accordance with at least some embodiments.

### DETAILED DESCRIPTION

This disclosure describes techniques and systems for providing improved retry timer implementation within a UE. Retry interval values may be generated based on one or more conditions detected in relation to a network. For example, a long retry interval value may be generated upon detecting that a network is currently unavailable or overloaded. In another example, a short retry interval value may be generated upon detecting that a network issue has just been resolved.

In some cases, the retry interval timer data may be stored at a location from which it may be retrieved by the UE. For example, the retry interval data may be stored at a gateway device in communication with the UE. In another example, the retry interval data may be stored at a node within a network (e.g., a P-CSCF node within an IMS network) that can be accessed by the UE. In other cases, the retry interval timer data may be provided to the UE, such as via a push notification.

During operation, a UE may attempt to establish a connection with a network, and that attempt may fail. In such cases, the UE may retrieve retry interval data from a location at which it is stored. In some cases, this retry interval data is retrieved by the UE before attempting to establish the connection (e.g., at periodic intervals). In other case, this retry interval data is retrieved by the UE after attempting to establish the connection (e.g., upon determining that the connection attempt has failed).

Once the UE has retrieved the retry interval data from its location, it may use that data during a connection retry process or method. More particularly, the UE, upon failing a connection request, may identify a retry interval value from the retry interval data that corresponds to the failed connection request. The UE may then wait an amount of time indicated in that retry interval value before reattempting to establish the connection. In some cases, the UE may receive (e.g., either by retrieving or being provided) updated retry interval data that replaces the current retry interval data. In such cases, the UE may shorten or lengthen a current wait time corresponding to the newly received updated retry interval data.

Embodiments of the disclosure provide for a number of advantages over conventional systems. For example, the implemented system allows for improved retry timing on UE devices. In conventional systems, a UE may be hard-coded to “retry” connection requests at predetermined intervals. In some cases, the hard-coded intervals may increase with each attempt. For example, the first time that a UE attempts reconnection and fails, it may be configured to wait 30 seconds before attempting to connect again. The second time that a UE attempts reconnection and fails, it may be configured to wait 60 seconds before attempting to connect again. The third time that a UE attempts reconnection and fails, it may be configured to wait 120 seconds before attempting to connect again. This may continue, with the interval between connection attempts continuing to increase. In this manner, the interval between connection attempts may increase substantially after each attempt.

While implementation of a hard-coded retry timer may be effective at reducing overall connection attempts from multiple UEs when an IMS network is unavailable, it may prevent the UE from connecting to the IMS network until much later than it becomes available (e.g., because of the increasing retry intervals) which can be problematic for many users. Alternatively, while the number of repeated connection requests when an IMS network is down are reduced when the UE uses increasing retry intervals, the number of connection requests may still be high enough to have a detrimental impact on the IMS network.

In embodiments, the implemented system can reduce the overall number of connection attempt requests when an IMS network is unavailable. At the same time, the implemented system allows for a UE to connect to the IMS network more quickly when it becomes available.

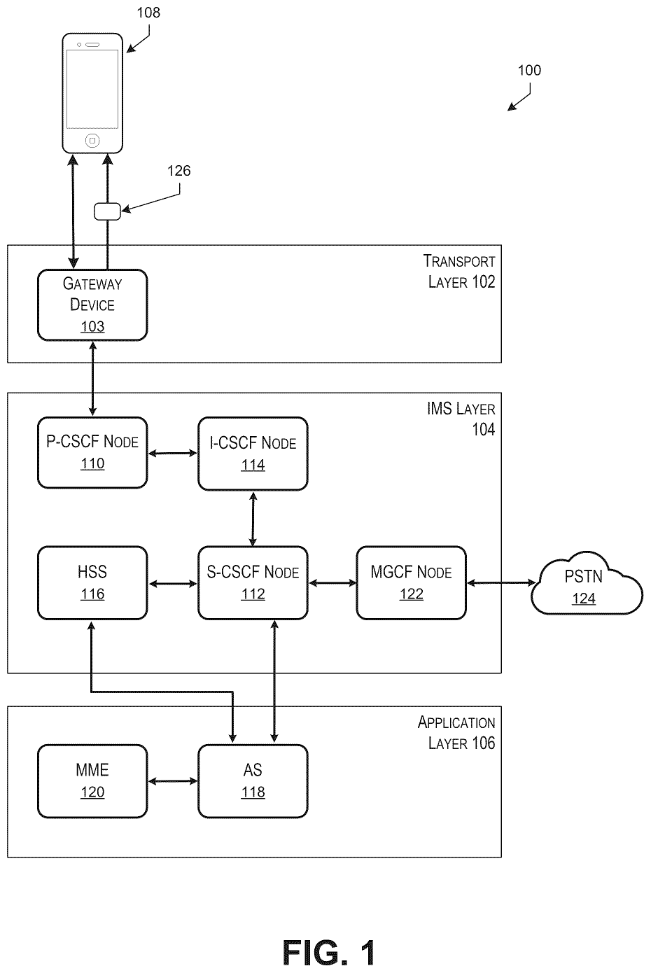

FIG. 1 depicts a diagram illustrating an overview of a network architecture 100 having a number of components that may be implemented in accordance with some embodiments. In embodiments, the network architecture 100 may be made up of multiple layers, each of which includes a different set of nodes. For example, the network architecture 100 may be representative of an IMS network that includes at least a transport layer 102, an IMS layer 104, and an application layer 106.

A transport layer 102 is responsible for connecting different access technologies users' devices to the IMS domain and for connection of the domain to other packet-switched and circuit-switched networks. A transport layer 102 may include any node (e.g., equipment) configured to provide access (e.g., ingress/egress) to the network architecture 100 for a number of user equipment (UE) 108. For example, a transport layer 102 may include a gateway device, such as a gateway device 103 that provides fixed access (e.g., digital subscriber line (DSL), cable modems, Ethernet, FTTx), mobile access (e.g., 5G NR, LTE, W-CDMA, CDMA2000, GSM, GPRS), and/or wireless access (e.g., WLAN, WiMAX).

An IMS layer 104 (also referred to as a control layer) may include any node configured to process SIP signaling packets within the network architecture 100. Such nodes may generally be referred to as Call Session Control Function (CSCF) nodes. CSCF nodes can be further distinguished based on their respective roles. For example, CSCF nodes may include a Proxy CSCF (P-CSCF), a Service CSCF (S-CSCF), and an Interrogating CSCF (I-CSCF). It is to be appreciated that the IMS network can include additional nodes that are not described herein such as nodes including, without limitation, an emergency CSCF (E-CSCF) node, a security gateway (SEG), a session border controller (SBC), and so on. In some cases, the IMS layer 104 may further include a Home Subscriber Server (HSS) 116. However, it should be noted that while the HSS 116 is depicted in the IMS layer 104 in FIG. 1, the HSS 116 may instead be implemented within an application layer 106 in some embodiments of a network architecture 100 or even outside of the IMS network.

A P-CSCF node is a proxy device that acts as a first point of contact for UE 108 within the IMS Network. Each UE is assigned to a respective P-CSCF when it is registered with the IMS Network. A P-CSCF node can receive, via a communications interface, a Session Initiation Protocol (SIP) request from the UE 108 to be forwarded to a S-CSCF.

A S-CSCF node is the central nodes of the signaling plane and sits on the path of all signaling messages to/from a UE 108 that is assigned to it. There can be multiple S-CSCFs in the network for load distribution and high availability reasons. A S-CSCF is typically assigned to a user (or UE) by a Home Subscriber Server (HSS), when it's queried by the I-CSCF.

A S-CSCF node 112 may represent one of multiple available S-CSCF nodes (e.g., 112 (A-C)) that is chosen (or otherwise selected) for assignment to the UE 108. S-CSCF nodes, such as the S-CSCF node 112 (A), are sometimes referred to as “Registrars,” and the process of allocating Registrars among users who are registering for IMS-based services is sometimes referred to as finding a “home CSCF” for the UE 108.

A I-CSCF node 114 is a SIP function node that acts as a forwarding point for external devices. The I-CSCF node 114 queries the HSS to determine S-CSCF/UE mapping and forwards SIP requests between the P-CSCF node 110 and the respective S-CSCF node 112.

The HSS 116 is typically a master user database that supports the IMS network nodes that handle the calls/sessions. It contains user profiles, performs authentication and authorization of the user, and can provide information about the physical location of a user. A user profile may be associated with each UE 108 and may contain information about the current user. Such information may be downloaded by the S-CSCF assigned to the user when the user is registered on the network. The S-CSCF may typically receive that information in a User-data Attribute Value Pair (AVP) format.

An application layer 106 (also referred to as a service layer) may include one or more nodes capable of providing IMS-related services to the UE 108. In embodiments, the application layer 106 may include at least a number of Application Servers (AS) 118, as well as a Mobility Management Entity (MME) 120. As noted above, the application layer 106 may further include a HSS 116 in some embodiments.

An AS 118 hosts and executes services, and interface with the S-CSCF using messages formatted using a SIP protocol. Depending on the actual service, the AS 118 can operate in SIP proxy mode, SIP UA (user agent) mode or SIP B2BUA mode. An AS 118 can be located in the network architecture 100 or in an external third-party network. If located in the network architecture 100, it may be able to query, or otherwise interact with the HSS 116 (e.g., using Diameter interfaces). In embodiments, the AS 118 manages an application that provides communication between two or more UEs (e.g., UE 108 and at least one other UE). For example, the AS 118 may manage an application that provides Voice over IP (VOIP) communications between UE devices.

In embodiments, an AS 118 may be configured to make service initiation decisions based on information about a UE 108 to which a communication is being directed. For example, the AS 118 may receive a communication directed to initiation of a service at a UE 108. By way of illustration, another UE may initiate a Voice over Internet Protocol (VOIP) call to a UE 108. In this illustration, the AS 118 receives a request to initiate the VoIP call as well as an identifier for the UE 108. Upon receiving such a communication, the AS 118 may retrieve information about the UE 108 from a second entity that maintains updated information about a status of the UE 108. Such a communication may be routed through the HSS 116. For example, the AS 118 may provide a request to the HSS 116 (which maintains information about services associated with the account for that UE 108) and the HSS 116 further communicates with an MME 120 to retrieve such information. The AS 118 may then make a determination about whether the service should or should not be initiated based on the received information and absent additional communications within the network architecture 100.

The network architecture 100 may include at least one node that provides a Media Gateway Control Function (MGCF) (e.g., MGCF node 122) that enables interaction between the IMS network and at least one other network, such as a telephonic network (Public Switched Telephone Network (PSTN) 124). In embodiments, a MGCF node may be configured to translate between SIP messaging and other formats in order to facilitate inter-network messaging.

The UE 108 may include any electronic device capable of interacting with the network architecture 100. In some non-limiting examples, the UE 108 may be a variety of devices including, for example: a mobile phone, a personal data assistant (PDA), or a mobile computer (e.g., a laptop, notebook, notepad, tablet, etc.) having mobile wireless data communication capability. The UE 108 may be configured to register for, and thereafter access and utilize, one or more IMS-based services via the network architecture 100. To this end, the UE 108 may be configured to transmit, via a radio access network (RAN), messages to the IMS network. For example, the UE 108 may transmit messages to the IMS network as part of an IMS registration procedure where the UE 108 is requesting to register for an IMS-based service.

In operation, the UE 108 may, upon registration with the network architecture 100, be assigned to a P-CSCF node 110 as well as a S-CSCF node 112. Communications from the UE 108 to an AS 118 of the network architecture 100 are then routed from the UE 108 to the P-CSCF node 110 and then to the S-CSCF node 112 (through forwarding by the I-CSCF node 114) and subsequently to the AS 118. Conversely, communications from an AS 118 of the network architecture 100 to the UE 108 are routed from the AS 118 to the S-CSCF node 112 and then to the P-CSCF node 110 and subsequently to the UE 108.

During operation, a UE 108 may attempt to initiate a connection with an IMS network via a respective transport layer 102. The UE 108 may make a determination that the IMS network is unavailable. In some cases, such a determination may be made if the UE receives an error code or erroneous response. In some cases, such a determination may be made if the UE does not receive a response within a predetermined amount of time. Either before or after attempting to connect to the IMS network and determining that the IMS network is unavailable, the UE 108 may receive an indication of one or more retry timers 126 to be implemented when making subsequent connection requests. In some cases, the one or more retry timers may be varied based on a category or type of the connection request failure (e.g., based on a received error code).

In accordance with various embodiments described herein, the terms “user equipment (UE),” “wireless communication device,” “wireless device,” “communication device,” “mobile device,” and “client device,” may be used interchangeably herein to describe any UE (e.g., the UE 108) that is capable of transmitting/receiving data over the IMS network, perhaps in combination with other networks. A users can utilize the UE 108 to communicate with other users and associated UEs via the IMS network. For example, a service provider may offer multimedia telephony services that allow a subscribed user to call or message other users via the IMS network using his/her UE 108. A user can also utilize the UE 108 to receive, provide, or otherwise interact with various different IMS-based services by accessing the IMS network. In this manner, an operator of the IMS network may offer any type of IMS-based service, such as, telephony services, emergency services (e.g., E911), gaming services, instant messaging services, presence services, video conferencing services, social networking and sharing services, location-based services, push-to-talk services, and so on.

Furthermore, the IMS network that includes the IMS nodes 110-114 may enable peer-to-peer, client-to-client, and/or client-to-server, communications over wired and/or wireless networks using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VOIP), Voice over LTE (VOLTE), IEEE 802.1x protocols, WiMAX, Wi-Fi, Data Over Cable Service Interface Specification (DOCSIS), digital subscriber line (DSL), and/or any future IP-based network technology or evolution of an existing IP-based network technology.

The network architecture 100 of FIG. 1 may be maintained and/or operated by one or more service providers, such as one or more wireless carriers (“operators”), that provide mobile IMS-based services to users (sometimes called “subscribers”) who are associated with UEs, such as the UE 108. The IMS network may represent any type of SIP-based network that is configured to handle/process SIP signaling packets or messages. SIP is a signaling protocol that can be used to establish, modify, and terminate multimedia sessions (e.g., a multimedia telephony call) over packet networks, and to authenticate access to IMS-based services. Individual nodes of the IMS nodes 110-114 of FIG. 1 can also be configured to transmit data to/from the HSS 116 using Diameter protocol over a Diameter interface. In one example, such a Diameter interface may be a Diameter (Cx) when the interface is accessed via a I/S-CSCF node. In another example, such a Diameter interface may be a Diameter (Sh) when the interface is accessed via an application server. Diameter protocol is defined by the Internet Engineering Task Force (IETF) in RFC 6733.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

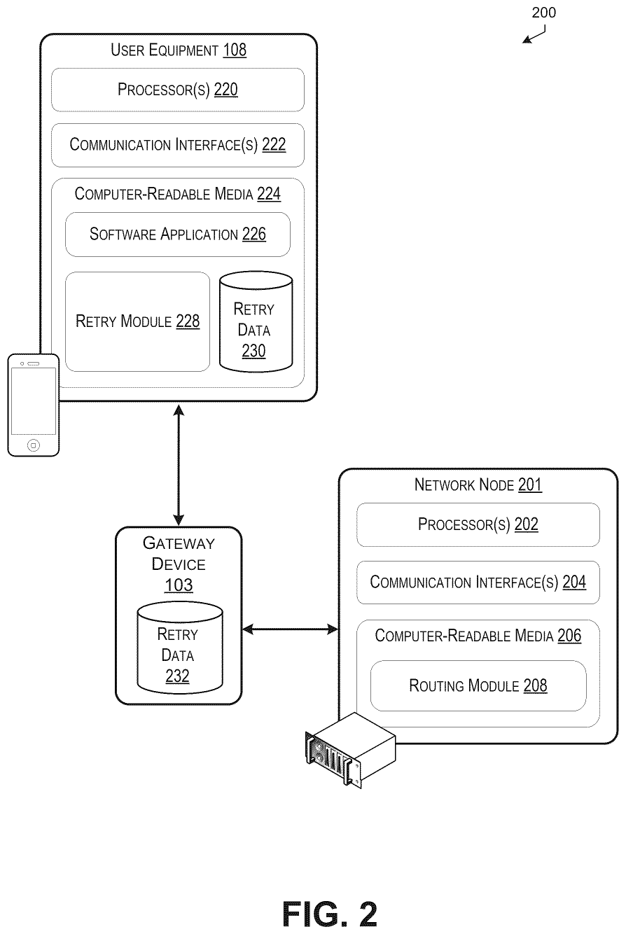

FIG. 2 depicts a component diagram of an example system to be implemented in a network (e.g., an IMS network) in order to enable implementation of dynamic connection interval values in accordance with some embodiments. As depicted in FIG. 2, a network node (e.g., an IMS node operating on an IMS network) 201 may be in wireless communication with a UE 108 that is operated by a user. The connection between the UE 108 and the network node operating on a network may be made over a gateway device 103.

In some embodiments, an exemplary network node 201 may be an example of an IMS node (e.g., 110-114) as described in relation to FIG. 1 above. In some embodiments, the network node 201 is implemented in communication with a gateway device 103. Gateway device 103 may be an example of the gateway device as described in relation to FIG. 1 above. It should be noted that such an IMS node (or any other described computing component) may include a single computing device (e.g., a server device) or a combination of computing devices. In some cases, the IMS node may be implemented as a virtual device/system (e.g., via virtual machines implemented within a cloud computing environment).

As illustrated, the network node 201 may include one or more hardware processors 202 configured to execute one or more stored instructions. Such processor(s) 202 may comprise one or more processing cores. Further, the network node 201 may include one or more communication interfaces 204 configured to provide communications between the network node 201 and other devices, such as the UE 108 or any other suitable electronic device.

The network node 201 may also include computer-readable media 206 that stores various executable components (e.g., software-based components, firmware-based components, etc.). The computer-readable media 206 may store components to implement functionality described herein. While not illustrated, the computer-readable media 206 may store one or more operating systems utilized to control the operation of the one or more devices that comprise the network node 201. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 206 may include portions, or components, that configure the network node 201 to perform various operations described herein. For example, the computer-readable media 206 may include some combination of components configured to implement the described techniques. Particularly, the network node 201 may include a component configured to route received network traffic to an appropriate destination (e.g., routing module 208). Additionally, the computer-readable media 206 may further maintain one or more databases.

A routing module 208 may be configured to, when executed by the processors 202, provide routing and switching functionality in relation to network traffic. For example, where the IMS node is a P-CSCF node (e.g., P-CSCF node 110 of FIG. 1), then the routing module 208 may be configured to route messages between the UE 108 and a S-CSCF node (e.g., S-CSCF node 112 of FIG. 1) assigned to that UE.

The UE 108 may be an example of a UE 108 as described in relation to FIG. 1 above. As noted elsewhere, a UE 108 may include any suitable electronic device configured to interact with a network.

Similar to the network node 201, the UE 108 may include one or more hardware processors 220 configured to execute stored instructions. Such processor(s) 220 may comprise one or more processing cores. Further, the UE 108 may include one or more communication interfaces 222 configured to provide communications between the UE 108 and other devices, such as a network node 201 or another suitable electronic device.

Similar to the network node 201, the UE 108 may include computer-readable media 224 that stores various executable components (e.g., software-based components, firmware-based components, etc.). The computer-readable media 224 may store components to implement functionality described herein. It should be appreciated by those skilled in the art that computer-readable storage media may include any available media that provides for the non-transitory storage of data and that can be accessed by the UE 108. In some examples, the operations performed by devices as described herein may be supported by one or more devices similar to UE 108. Stated otherwise, some or all of the operations performed by a UE, and/or any components included therein, may be performed by one or more computing device operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The computer-readable media 224 may include portions, or components, that configure the UE 108 to perform various operations described herein. For example, the computer-readable media 224 may include some combination of components configured to implement the described techniques. In embodiments, the computer-readable media 224 of the UE 108 may include one or more software application 226. The computer-readable media 224 may further include a component configured to schedule connection retry attempts after a network disconnection (e.g., retry module 228). Additionally, the computer-readable media 224 may further maintain one or more databases, such as a database of information maintained in relation to retrying connection request attempts (e.g., retry data 230).

A software application 226 may be any suitable set of computer-executable instructions that causes the UE 108 to perform a function. In embodiments, the software application 226 may be supported by a remote server, such as an AS 118 as described in relation to FIG. 1 above. In other words, when executed, the software application may cause the UE 108 to communicate with a remote server to perform at least a portion of the functionality provided by that software application 226. The network traffic generated during such a communication may be transmitted to the gateway device 103 to be routed to its intended destination device.

A retry module 228 may be configured to, when executed by the processors 220, cause the UE 108 to attempt to reestablish a connection to the network using dynamic retry data 230. In embodiments, the UE 108 may retrieve one or more values to be stored as retry data 230 from the gateway device 103. In some cases, the retry data 230 may include retry time interval values that correspond to different conditions. For example, the retry data may include a first time interval value that corresponds to a scenario in which a network is unresponsive. That first time interval value may vary from a second time interval value that corresponds to a scenario in which a response is received from the network that includes an error code.

In some cases, the UE 108 may receive updated retry data 230 from one or more nodes operating on a network. In some cases, the retry data 230 is received periodically (e.g., every hour). In other cases, the retry data 230 is pushed to the UE 108 by one or more devices operating on the network as that retry data 230 is updated.

During operations, at a first time that occurs during a network outage, a time interval included in the retry data 230 may be set to 30 minutes. In this example, that time interval may be provided to the UE 108. In some cases, the UE 108 may access a location at which the time interval value is stored and may retrieve and store that time interval value. In some cases, a device operating on the network (e.g., a gateway device 103) may push the time interval value to the UE 108. The retry module 228 may be configured to continue to attempt to reestablish a connection with the network every 30 minutes until either a connection is reestablished, or an updated time interval value is received. As noted elsewhere, the UE 108 may periodically (e.g., every 5 minutes) connect to a device (e.g., gateway device 103 or another suitable device) to retrieve the current time interval value.

At a second time that occurs after the network outage has been resolved (e.g., the network becomes available), the time interval value may be updated to be 30 seconds. At that time, the updated time interval value may be sent to the UE 108. The UE 108, upon receiving the updated time interval value, may overwrite a current time interval value stored in retry data 230. Alternatively, the UE 108 may retrieve the updated time interval value during a periodic data retrieval. Upon the time interval value being updated to the new value (e.g., 30 seconds), the retry module 228 may be configured to attempt to reestablish the connection to the network after the newly indicated time interval.

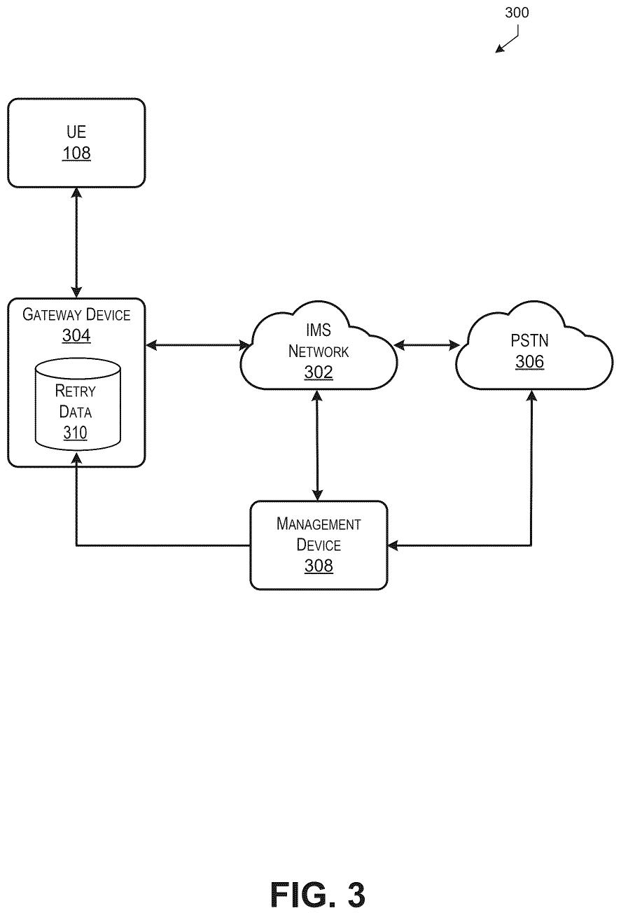

FIG. 3 depicts a block diagram illustrating exemplary interactions between a number of components that may be implemented in accordance with some embodiments. As noted elsewhere (e.g., such as in relation to FIG. 1) a network architecture may include a number of components configured to interact as described herein. More particularly, the network architecture 300 may include at least an IMS network 302 that is in communication with, and provides service to, at least one UE 108 via at least one gateway device 304. As also noted, the IMS network 302 may be further in communication with at least one second network, such as a PSTN 306. In such cases, the UE 108 may typically access services offered through the PSTN 306 via the IMS network 302. In some embodiments, a management device 308 may be in communication with the various other components of the network architecture 300 in order to detect operating conditions of those components and to provide updated retry interval data based on those detected operating conditions.

Management device 308 may include any suitable computing device that is capable of providing updated retry interval data to one or more UEs 108. In some cases, the management device 308 is capable of monitoring a status of one or more components as implemented in the network architecture 300. In some cases, the management device 308 may, while monitoring the various components, detect one or more networks is down (e.g., unavailability) or overloaded. In such cases, the management device 308 may generate a retry interval value that represents a longer time period than a typical (e.g., default) retry interval value that is implemented. In some cases, the retry interval value may represent an expected (e.g., average) amount of time that is needed to resolve issues/restore operation of the various components. For example, if an average downtime for the PSTN 306 during outages is 30 minutes, then the management device 308 may assign a retry interval value of 30 minutes to connection requests directed toward that PSTN 306.

In some cases, the management device 308 may detect that an outage/issue associated with the network (e.g., IMS network 302 or PSTN 306) has been resolved. In such cases, the management device 308 may generate updated retry interval data that includes a retry interval value that is relatively small (e.g., 30 seconds). The management device 308 may be configured to push the updated retry interval data 310 to the gateway device 304 (or to one or more nodes within the IMS network 302). In some cases, the updated retry interval data 310 may be actively sent to the UE 108 (e.g., via a push notification) to be implemented immediately.

It should be noted that while retry interval data 310 is depicted as being stored by, and retrieved by the UE 108 from, a gateway device 304 in FIG. 3, the retry interval data 310 may instead be stored on one or more nodes of the IMS network 302. For example, a retry interval data 310 may instead be stored at a P-CSCF node of the IMS network 302 to be retrieved by any UE 108 to which that P-CSCF node is assigned.

By way of illustration, consider the following scenario. In operation, a UE 108 may attempt to establish a connection with either the IMS network 302 or another network (e.g., PSTN 306) via the gateway device 304. During this action, the connection request may fail. In some cases, this may mean that the UE 108 has received an error code in response to the connection attempt that indicates a failure. In other cases, this may mean that the UE 108 has not received a response to the connection attempt for a predetermined amount of time.

In this scenario, the UE 108 may receive an indication of one or more retry interval value from retry data 310. In some cases, the UE 108 may receive the retry interval value before detecting the connection request failure. For example, the UE 108 may retrieve the retry interval value from its location within retry data 310 at periodic intervals. In other cases, the UE 108 may receive the retry interval value after (e.g., in response to) detecting the connection request failure. For example, upon receiving a connection request failure, the UE 108 may be configured to retrieve the retry interval value from the retry data 310 at its access location. Furthermore, a retry interval value may be pushed to the UE 108 (by the gateway device 304 or another suitable device) or it may be retrieved from its access location by the UE 108.

Upon receiving the retry interval value from the retry interval data 310, the UE 108 may wait for a period of time indicated in the retry interval value. At the end of that period of time, the UE 108 may once again attempt to establish the connection. If the connection request fails once more, then the UE 108 may once again wait for the period of time before reattempting the connection.

In some cases, however, an issue with the network may be resolved and the retry interval value stored in retry interval data 310 may be updated to be a shorter amount of time. In these cases, the updated retry interval value is received by the UE 108 and the amount of time that the UE 108 waits between connection requests is then updated accordingly.

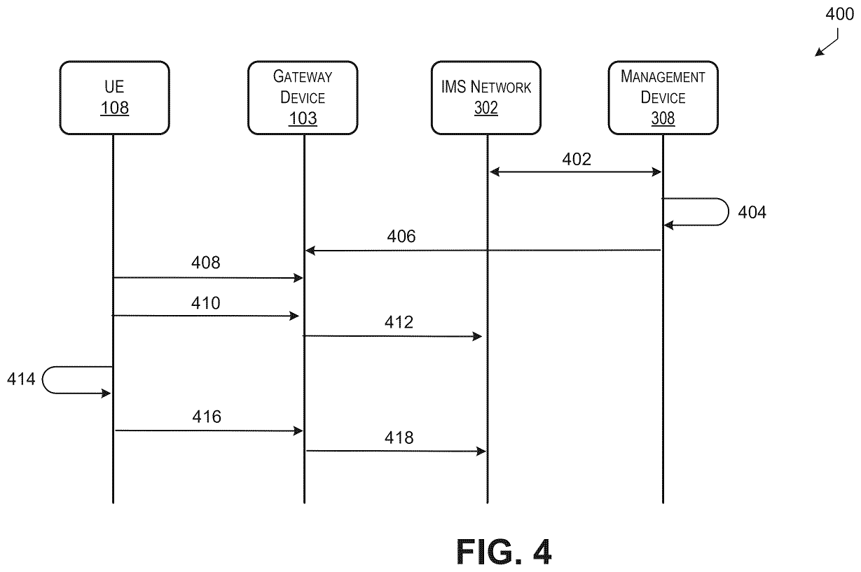

FIG. 4 depicts a swim lane diagram illustrating a process for enabling implementation of dynamic connection retry timers in accordance with at least some embodiments. More particularly, the block diagram illustrates example signaling between a UE (e.g., UE 108) and components of various networks to intelligently reestablish a communication session for the UE.

As noted elsewhere, some embodiments may include a management device 308 configured to monitor one or more conditions associated with various networks at 402. The management device 308 may be further configured to determine appropriate retry interval values based on those conditions at 404. In embodiments that include a management device 308, that management device 308 may be configured to generate retry interval data and provide that data to an appropriate entity at 406. In some cases, the retry interval data may be provided to a gateway device 103 to be stored and later provided to the UE 108. Alternatively, as noted elsewhere, a UE 108 may be assigned to both a P-CSCF node as well as a S-CSCF node during a registration process for the UE 108 with an IMS network. In some cases, the retry interval data is provided to the P-CSCF node to be provided to the UE 108.

At 408, the UE 108 may access (e.g., retrieve) retry interval data stored at an access location, such as stored in memory of a gateway device 103 or on a P-CSCF node assigned to that UE 108. In some cases, the retry interval data may include an indication of multiple retry interval values, with each of those retry interval values being associated with a set of conditions (e.g., particular error codes, etc.).

The UE 108 may attempt to establish a communication session with one or more network. For example, the UE 108 may attempt to establish a communication session between itself and an IMS network 302 or a PSTN (e.g., PSTN 124 as described in relation to FIG. 1 above). In order to establish this communication session, the UE 108 may first connect to a gateway device 103 at 410. As noted elsewhere, the gateway device 103 may include any suitable electronic device that can be used to provide egress/ingress to one or more networks. In some cases, such a gateway device 103 may include one or more components of a wireless communication network, such as a cellular network. Through the gateway device 103, the UE 108 can be connected to a P-CSCF node of an IMS network 302 at 412. In some cases, the IMS network may be configured to connect the UE 108 to a second network, such as a PSTN as described elsewhere.

As noted, the connection request initiated at 410 may fail. In some cases, the connection request failure may be detected upon the UE 108 receiving a connection failure message (e.g., a message indicating an error code). In some cases, the connection request failure may be detected by the UE 108 if it does not receive a response to the connection request. For example, the connection request may “time out” in which a predetermined amount of time may be reached following the connection request without receiving a response to that connection request.

At 414, the UE 108 may wait an amount of time associated with a retry interval value. In some cases, the UE 108 may have stored a single retry interval value which is then selected for use in the connection retry process. In other cases, such as when multiple retry interval values are stored by the UE 108, the UE may first determine which retry interval value is relevant to the current connection request. In embodiments, this may involve comparing one or more conditions to a set of conditions associated with each of the retry interval values. For example, a particular retry interval value may be associated with a particular error code, such that the UE 108 is configured to select that retry interval value upon determining that the connection request has failed with that error code. In another example, a particular retry value may be associated with a number of connection request failures, such that it may be relevant after that number of connection attempts have failed in a row.

After waiting an amount of time that corresponds to the selected retry time interval value, the UE 108 may once again attempt to establish a communication session with the network. Similar to 408, the UE may initially connect to a gateway device 103 at 416. Through the gateway device 103, the UE 108 can be connected to a P-CSCF node of an IMS network 302 at 418. At that point, the connection request may be successful, or it may once again fail. Provided that the connection request fails once more, the UE 108 may then select a different retry interval value that correlates to the number of failed connection requests.

As noted elsewhere, retry interval data that is stored at, and used by, the UE 108 may be replaced by updated retry interval data during a connection retry process. In such cases, a current wait process may be abridged or cut short if the updated retry interval value is less than the one that it replaced. Alternatively, the current wait process may be extended if the updated retry interval value is greater than the one that it replaced.

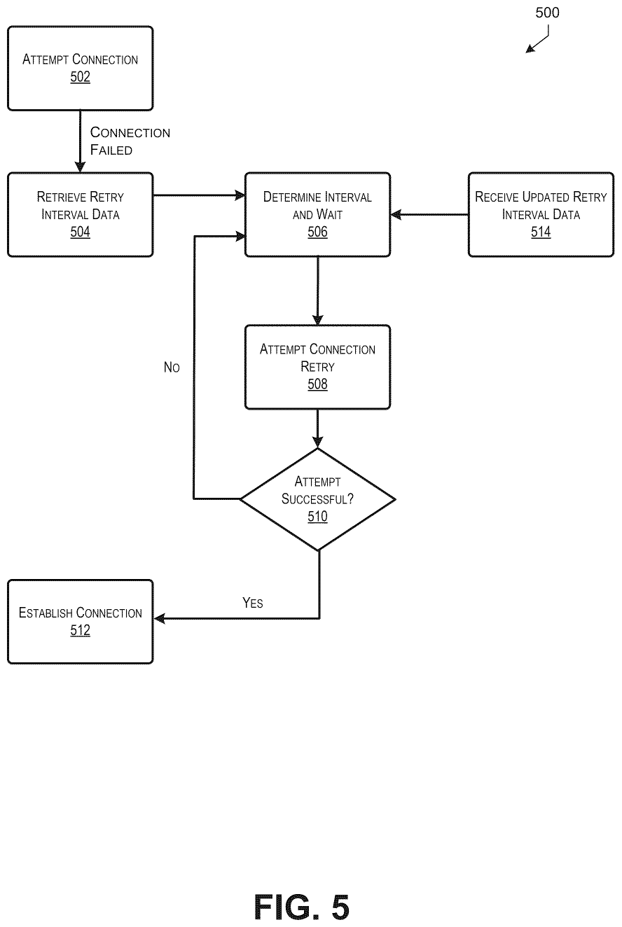

FIG. 5 depicts a flow chart illustrating an exemplary process for performing a connection retry process in accordance with some embodiments. In embodiments, the process 500 may be performed by a UE, such as the UE 108 as described in relation to FIG. 1 above.

At 502, the UE may attempt to establish a connection with a network. As noted elsewhere, the network may be an IMS network that provides services to mobile devices. In other cases, the connection to be establish may be between the UE and another network that can be accessed over the IMS network, such as a PSTN that provides voice call services.

As depicted in the flow chart for process 500, the attempted connection may fail. As noted elsewhere, such a failure may be detected based on a response received from the network, such as a response that includes an error code. In other cases, such a failure may be detected based on the UE having not received any response within an elapsed period of time.

Upon detecting a connection attempt failure, the UE may receive retry interval data at 504. In some cases, the UE may retrieve the retry interval data from a location in memory at which it is stored. For example, the retry interval data may be retrieved from a memory location of a gateway device or a node operating on a network to which the UE is attempting to connect. In other cases, the UE may receive the retry interval data from an entity that provides that data to it (e.g., via a push notification).

In some cases, the UE may receive the retry interval data prior to attempting to establish the connection. For example, the UE may be configured to retrieve retry interval data on a periodic basis. In other cases, the UE may receive the retry interval data after attempting to establish the connection, such as in response to detecting that the connection attempt has failed.

Upon determining the connection attempt has failed, the UE may be configured to identify a retry interval value to be implemented from the received retry interval data at 506. In some cases, a number of different retry interval values may be associated with varying sets of conditions (e.g., error codes, number of previous failed connection attempts, etc.), such that the UE may determine which retry interval value is applicable based on each of the conditions associated with that retry interval value being met. In some cases, the retry interval data may include a default retry interval value that will be selected if no other retry interval value is determined to be applicable. The UE may, upon determining the appropriate retry interval value, wait for an amount of time to elapse that corresponds to a period of time indicated in the determined retry interval value.

Once an amount of time corresponding to the retry interval value has elapsed, the UE may once again attempt to establish the connection at 508. A determination may then be made at 510 as to whether the connection attempt was successful. This may involve once more detecting a failed connection attempt based on a received response or a lack thereof.

Upon making a determination that the connection attempt was unsuccessful (e.g., “No” at 510), the UE may once more determine an appropriate retry interval value and perform the wait operation. It should be noted that the retry interval value that is determined to be appropriate at this step may be different from the retry interval value that was previously determined. For example, each subsequent time that a connection request fails, a retry interval value corresponding to a longer period of time may be selected.

Upon making a determination that the connection attempt was successful (e.g., “Yes” at 510), the UE may establish a communication session between itself and the network (e.g., with a P-CSCF node of an IMS network). Data packets may then be routed over that communication session between the two devices.

In some cases, the UE may receive updated retry interval data at 514. In some cases, the UE may check for updated retry interval data at periodic intervals and may retrieve updated retry interval data when it is detected. In other cases, the UE may receive a communication (e.g., a push notification) from another entity that includes the updated retry interval data. As noted elsewhere, the updated retry interval data may include one or more retry interval values that are different (e.g., shorter or longer) than those of the retry interval data currently stored on the UE. Based on receiving the updated retry interval data, the UE may be configured to once more determine an appropriate (updated) retry interval value pertaining to the current conditions. In such cases, the UE may then be configured to either shorten or lengthen the wait time interval based on whether the determined retry interval value is shorter or longer. In such cases, the UE may make a determination as to whether the current elapsed wait time is greater than the retry interval value. If the current elapsed wait time is greater than the retry interval value, then the UE may make the connection attempt right away.

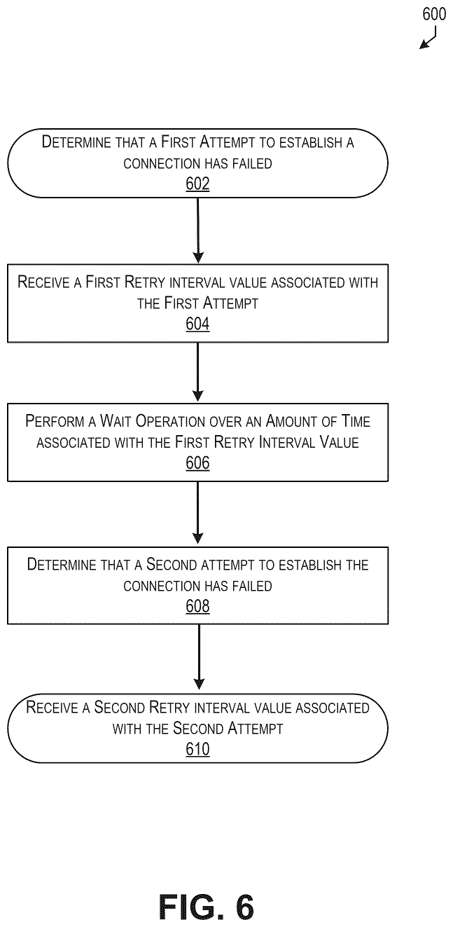

FIG. 6 depicts a flow diagram illustrating an exemplary process for providing intelligent connection retry timing in accordance with at least some embodiments. In embodiments, the process 600 as depicted in FIG. 6 may be performed by a UE in communication with a network (e.g., an IMS network).

At 602, the process 600 may involve determining that a first attempt to establish a connection has failed. In some cases, the first attempt to establish the connection with the network may be determined to have failed based on a response message received from the network. For example, the response message may include an error code indicating a failure. IN other cases, the first attempt to establish the connection with the network may be determined to have failed based on the UE not receiving a response to the attempt to establish the connection within a period of time.

At 604, the process 600 may involve receiving a first retry interval value associated with the first attempt to establish the connection. The retry interval value is received from a computing device that is separate from the UE. For example, the retry interval value may be received from a gateway device or from one or more nodes (e.g., a P-CSCF node) operating on a network. In some cases, the first retry interval value is received from a gateway device that provides access to the network. In other cases, the first retry interval value is received from a node device operating on the network.

In some embodiments, the UE may receive retry interval data that includes multiple retry interval values and the retry interval value may be selected from multiple retry interval values. In these embodiments, the retry interval value may be selected from the multiple retry interval values based on one or more conditions associated with the first attempt to establish the connection. For example, the one or more conditions associated with the first attempt relate to an error code received in a message in response to the first attempt to establish the connection. In another example, the one or more conditions associated with the first attempt relate to a number of connection attempts.

At 606, the process 600 may involve performing a wait operation over an amount of time associated with the first retry interval value. The process 600 may then involve performing a second attempt to establish the connection with the network upon expiration of the amount of time.

In some embodiments, the UE may receive an updated retry interval value associated with either the first attempt or the second attempt to establish the connection. In such embodiments, the updated retry interval value may be received during one of the wait operations. The UE may then update the amount of time based on the updated retry interval value.

At 608, the process 600 may involve determining that a second attempt to establish the connection has failed. Such a failure may be determined in a manner similar to that used to determine the failure of the first connection attempt.

At 610, the process 600 may involve receiving a second retry interval value associated with the second attempt to establish the connection. In such cases, the second retry interval value may be different from the first retry interval value. The process 600 may then involve performing a second wait operation over a second amount of time associated with the second retry interval value and performing, at the expiration of the second amount of time, a third attempt to establish the connection with the network.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
determining, by a User Equipment (UE), that a first attempt to establish a connection with a network has failed;
receiving, by the UE from a computing device separate from the UE, a retry interval value associated with the first attempt to establish the connection;
performing, by the UE, a wait operation over an amount of time associated with the retry interval value; and
performing, by the UE at an expiration of the amount of time, a second attempt to establish the connection with the network.

2. The method of claim 1, wherein the first attempt to establish the connection with the network is determined to have failed based on a response message received from the network.

3. The method of claim 2, wherein the response message includes an error code indicating a failure.

4. The method of claim 1, wherein the first attempt to establish the connection with the network is determined to have failed based on the UE not receiving a response to the first attempt to establish the connection within a period of time indicated in the retry interval value.

5. The method of claim 1, further comprising receiving, by the UE from the computing device, a second retry interval value associated with the second attempt to establish the connection, the second retry interval value different from the first retry interval value.

6. The method of claim 5, further comprising:
determining, by the UE, that the second attempt to establish the connection with the network has failed;
performing, by the UE, a second wait operation over a second amount of time associated with the second retry interval value; and
performing, by the UE at the expiration of the second amount of time, a third attempt to establish the connection with the network.

7. The method of claim 1, further comprising:
receiving, by the UE during the wait operation, an updated retry interval value associated with the first attempt to establish the connection; and
updating, by the UE, the amount of time based on the updated retry interval value.

8. A User Equipment (UE) device comprising:
one or more processors; and
one or more non-transitory computer-readable media storing computer-executable instructions that, when executed by the one or more processors, cause the UE device to perform operations comprising:
determining that a first attempt to establish a connection with a network has failed;
receiving, from a computing device separate from the UE device, a retry interval value associated with the first attempt to establish the connection;
performing a wait operation over an amount of time associated with the retry interval value; and
performing, at an expiration of the amount of time, a second attempt to establish the connection with the network.

9. The UE device of claim 8, wherein the computing device comprises a gateway device that provides access to the network.

10. The UE device of claim 8, wherein the computing device comprises a node device operating on the network.

11. The UE device of claim 8, wherein the operations further comprise receiving, from the computing device, a second retry interval value associated with the second attempt to establish the connection, the second retry interval value different from the retry interval value.

12. The UE device of claim 8, wherein the retry interval value is selected from multiple retry interval values included in retry interval data.

13. The UE device of claim 12, wherein the retry interval value is selected from the multiple retry interval values based on one or more conditions associated with the first attempt to establish the connection.

14. The UE device of claim 13, wherein the one or more conditions associated with the first attempt relate to an error code received in a message in response to the first attempt to establish the connection.

15. The UE device of claim 13, wherein the one or more conditions associated with the first attempt relate to a number of connection attempts.

16. A system comprising:
a network comprising one or more nodes;
a gateway device; and
at least one UE, the at least one UE configured to:
perform a first attempt to establish a communication session over the network via the gateway device;
determine that the first attempt to establish the communication session was unsuccessful;
receive a retry interval value associated with the attempt to establish the communication session;
perform a wait operation over an amount of time associated with the retry interval value; and
perform, at an expiration of the amount of time, a second attempt to establish the communication session over the network.

17. The system of claim 16, wherein the retry interval value is received prior to performing the first attempt to establish the communication session.

18. The system of claim 16, wherein the retry interval value is received after performing the first attempt to establish the communication session.

19. The system of claim 16, wherein the retry interval value is retrieved from the gateway device.

20. The system of claim 16, wherein the retry interval value is retrieved from the one or more nodes.
